(19) United States
(12) Patent Application Publication
(10) Pub. No.: US 2026/0005469 A1
(43) Pub. Date: Jan. 1, 2026

(54) PIN AND SLEEVE BACK BODY AND CLAMP

(71) Applicant: Pass & Seymour, Inc., Syracuse, NY (US)

(72) Inventors: Michael V. Haubert, Mount Holly, NC (US); Charles S. Brown, Lake Wylie, SC (US); Ladd N. Brooksby, Charlotte, NC (US)

(73) Assignee: Pass & Seymour, Inc., Syracuse, NY (US)

(21) Appl. No.: 19/241,189

(22) Filed: Jun. 17, 2025

Related U.S. Application Data
(60) Provisional application No. 63/665,607, filed on Jun. 28, 2024.

(51) Int. Cl. H01R 13/58; H01R 13/52

(52) U.S. Cl. CPC H01R 13/582; H01R 13/5205

(57) ABSTRACT

An exemplary pin and sleeve device and a locking is described. A cord clamp is placed on a compression screw as opposed to the connector back body and has two portions that can slide away from and toward each other and accept a cord therebetween. This allows for the acceptance of a cord of a larger diameter, allowing the pin and sleeve device to accommodate a wider range of cords rather than relying on two pivoting pieces that cannot be altered to increase or decrease the opening therebetween. An assembly utilizing a watertight or non-watertight secondary thread can be used in place of a cord clamp assembly.

### CROSS-REFERENCE TO RELATED APPLICATION

This application claims priority to U.S. Provisional Patent Application No. 63/665,607 filed on Jun. 28, 2024, the entirety of which is incorporated herein by reference.

### BACKGROUND OF THE INVENTION

### 1. Field of the Invention

The present invention relates generally to a plug and connector device, and more particularly to an improved pin and sleeve device and locking device.

### 2. Description of the Related Art

Conventional pin and sleeve devices are well known in the art. See, e.g., IEC 60309. Conventional locking devices are also well known in the art. See, e.g., NEMA WD 6. These devices typically comprise cord clamps placed on a plug or connector back body and a compression screw that screws into the back body, compressing the cord seal. The compression of the cord seal causes a reduction of the inner diameter that seals the outside surface of the cord, and the compression causes an increase of the outer diameter sealing the inside surface of the back body, which effectively prevents the encroachment of solids and fluids.

Description of the Related Art Section Disclaimer: To the extent that specific patents/publications/products are discussed above in this Background Section or elsewhere in this Application, these discussions should not be taken as an admission that the discussed patents/publications/products are prior art for patent law purposes. For example, some or all of the discussed patents/publications/products may not be sufficiently early in time, may not reflect subject matter developed early enough in time and/or may not be sufficiently enabling so as to amount to prior art for patent law purposes. To the extent that specific patents/publications/products are discussed above in this Background Section and/or throughout the application, the descriptions/disclosures of which are all hereby incorporated by reference into this document in their respective entirety(ies).

### BRIEF SUMMARY OF THE INVENTION

The inventors of the present disclosure recognize that there are problems and limitations with conventional pin and sleeve and locking devices. For example, such devices cannot accommodate cords of a relatively larger diameter than current average sizes (as should be appreciated by those of ordinary skill in the art in conjunction with this disclosure). Thus, there is a need for an improved pin and sleeve device and a locking device that can be used with a greater range of cord sizes/diameters that are capable of being passed through the back body of the plug or connector.

It is therefore a principal object and advantage of the present invention to provide a pin and sleeve device and a locking device that eliminates one or more of the problems/issues associated with conventional products. A particular non-limiting goal of the utilization of the embodiments and implementations herein is to provide a pin and sleeve device and a locking device having, but is not limited to, a back body that has an internal thread at one end and a tapered feature on the inner surface that facilitates compression of a cord seal. A cord clamp placed on a compression screw is provided and further includes two portions that can expand and retract or return to position (e.g., slide away from and toward each other) to accept a cord therebetween, thereby allowing for the acceptance of a larger range of cord diameters.

In accordance with an embodiment, the cord clamp assembly can include a back body and a cord clamp releasably coupled to the back body. The cord clamp assembly can include a base, a first clamp portion and a second clamp portion coupled to the base, wherein the first and second clamp portions are cooperatively configured to define a cord-receiving opening. At least one of the first and second clamp portions can be further configured to move relative to the other to adjust a diameter of the cord-receiving opening. In this embodiment, moving the at least one of the first and second clamp portions from a first position to a second position increases the diameter of the cord-receiving opening to a first diameter, and moving the at least one of the first and second clamp portions from the second position to a third position increases the diameter of the cord-receiving opening to a second diameter.

In some embodiments, the second diameter is larger than the first diameter.

In some embodiments, the first and second clamp portions are biased in position via one or more compression screws.

In some embodiments, an anti-rotation screw is coupled to the base of the cord clamp.

In some embodiments, the at least one of the first and second clamp portions are configured to move along a longitudinal axis relative to the cord clamp.

In some embodiments, the first clamp portion is an unthreaded cord clamp and the second clamp portion is a threaded cord clamp.

In some embodiments, a cord seal configured to be positioned between the back body and the cord clamp when assembled is included.

In some embodiments, the back body and the cord clamp form a central cavity therebetween when assembled.

In some embodiments, a plurality of first threads are integrally formed with the back body.

In some embodiments, a plurality of second threads integrally formed with the cord clamp and configured to match with the plurality of first threads of the back body are included.

In accordance with another embodiment, a pin and sleeve device is provided that can include a cord clamp configured to be releasably coupled to a back body. The cord clamp can include a base, a first clamp portion and a second clamp portion coupled to the base, wherein the first and second clamp portions are cooperatively configured to define a cord-receiving opening. At least one of the first and second clamp portions can be further configured to move relative to the other to adjust a diameter of the cord-receiving opening. In this embodiment, moving the at least one of the first and second clamp portions from a first position to a second position increases the diameter of the cord-receiving opening to a first diameter, and moving the at least one of the first and second clamp portions from the second position to a third position increases the diameter of the cord-receiving opening to a second diameter.

### BRIEF DESCRIPTION OF THE DRAWINGS

The present invention will be more fully understood and appreciated by reading the following Detailed Description in conjunction with the accompanying drawings. The accompanying drawings illustrate only typical embodiments of the disclosed subject matter and are therefore not to be considered limiting of its scope, for the disclosed subject matter may admit to other equally effective embodiments.

Reference is now made briefly to the accompanying drawings, in which:

FIG. 1 is a perspective view of a conventional plug and connector according to the prior art.

FIG. 2 is an exploded view of the conventional plug and connector shown in FIG. 1 according to the prior art.

FIG. 3 is an expanded view of a conventional plug and connector and cord according to the prior art.

FIG. 4 is another expanded view of a conventional plug and connector according to the prior art.

FIG. 5 is another expanded view of a conventional plug and connector according to the prior art.

FIG. 6 is a perspective view of an assembled conventional plug and connector according to the prior art.

FIG. 7 is an exploded view of an exemplary pin and sleeve device according to an aspect of the present disclosure.

FIG. 8 is another exploded view of an exemplary pin and sleeve device according to an aspect of the present disclosure.

FIG. 9 is a close-up view of the cord clamp assembly according to an aspect of the present disclosure.

FIG. 10 is an exploded side view of an exemplary pin and sleeve device with a cord according to an aspect of the present disclosure.

FIG. 11 is a perspective view of an exemplary locking plug and connector back body.

FIG. 12 is a perspective view of an assembly utilizing a secondary thread.

### DETAILED DESCRIPTION OF THE INVENTION

Aspects of the present embodiments and certain features, advantages, and details thereof, are explained more fully below with reference to the non-limiting examples illustrated in the accompanying drawings. Descriptions of well-known structures are omitted so as not to unnecessarily obscure the invention in detail. It should be understood, however, that the detailed description and the specific non-limiting examples, while indicating aspects of the invention, are given by way of illustration only, and are not by way of limitation. Various substitutions, modifications, additions, and/or arrangements, within the spirit and/or scope of the underlying inventive concepts will be apparent to those skilled in the art from this disclosure.

While embodiments of the present invention have been particularly shown and described with reference to certain exemplary embodiments, it will be understood by one skilled in the art that various changes in detail may be affected therein without departing from the spirit and scope of the invention as defined by claims that can be supported by the written description and drawings. Further, where exemplary embodiments are described with reference to a certain number of elements it will be understood that the exemplary embodiments can be practiced utilizing either less than or more than the certain number of elements. If elements shown in a particular Figure discussed below are not specifically identified with respect to that Figure, the elements should be sufficiently identified with respect to at least one other Figure.

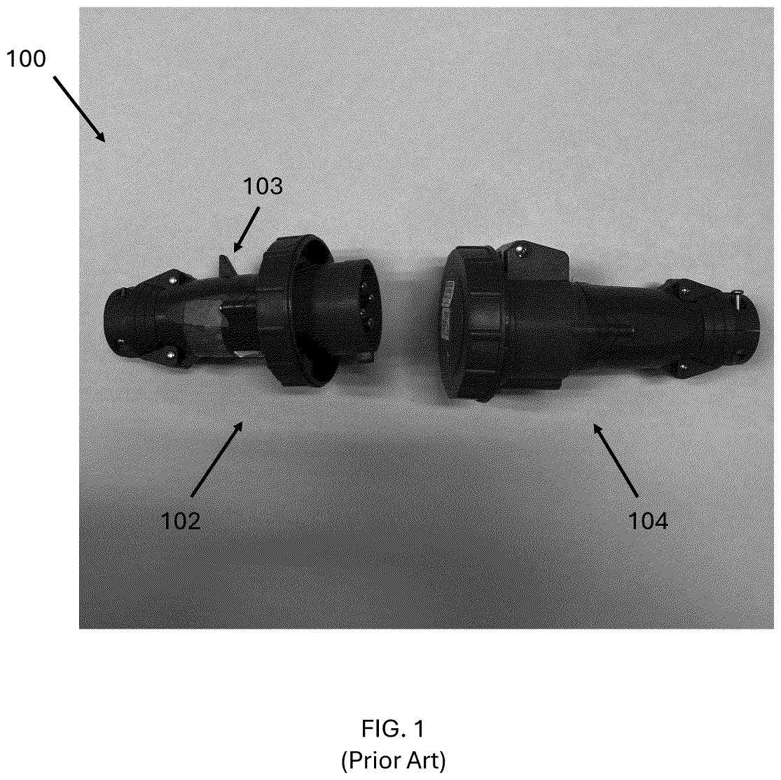

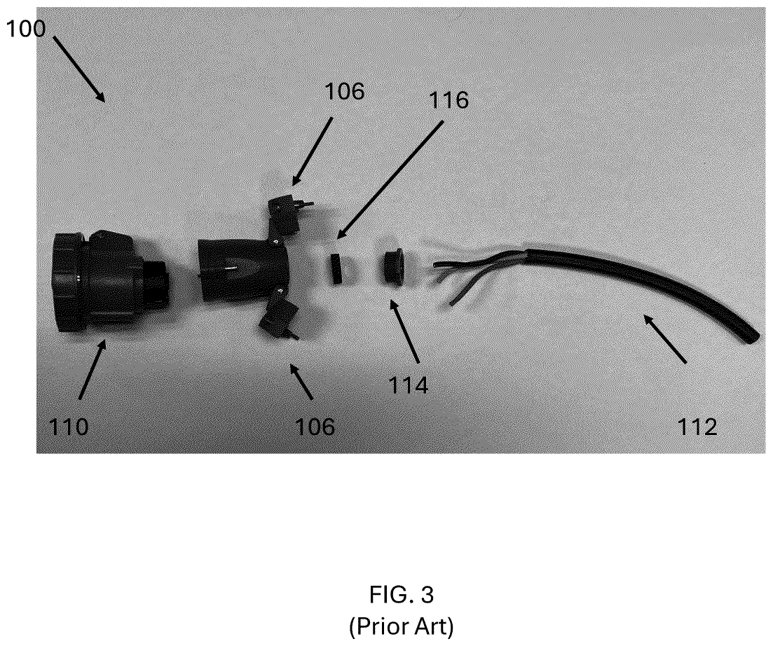

Referring now to FIGS. 1-6, a conventional plug and connector device 100 is shown (e.g., IEC-60309). An example is shown in FIG. 1, with a plug 102 on the left and a connector 104 on the right. In these conventional devices 100, in order to receive and hold a cord of a conventional diameter, a cord clamp 106 is used on the back body 108 of the connector with two moveable portions, each of which pivots outward to accept the cord and close and lock over the same (see, e.g., FIG. 3).

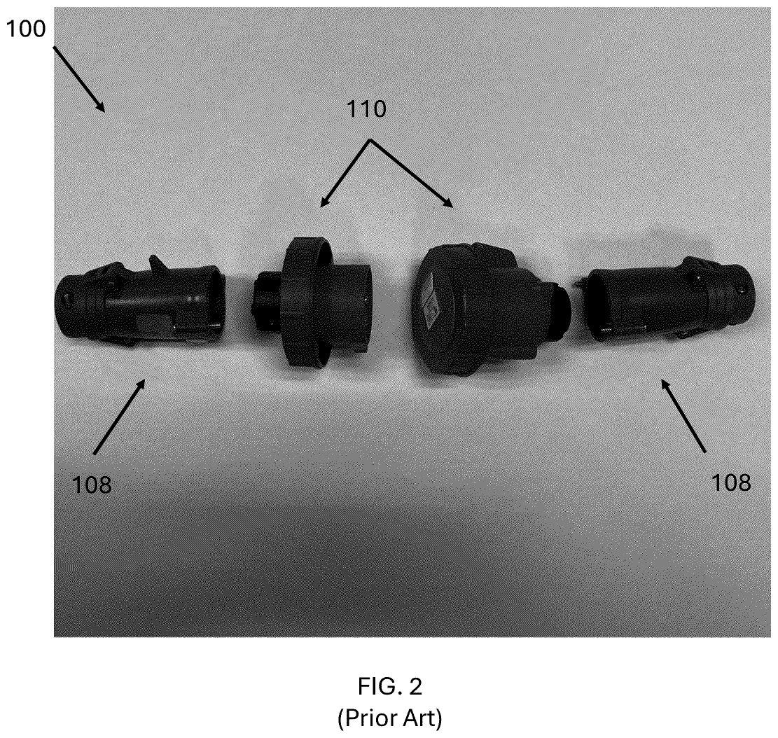

Referring now to FIG. 2, the back bodies 108 are removed from the contact assemblies 110 of the conventional plug and connector device 100 for illustration purposes.

Referring now to FIG. 3, an exploded image of the conventional plug and connector 100 is shown with a cord 112. In this example, the cord clamps 106 are affixed to the back body 108.

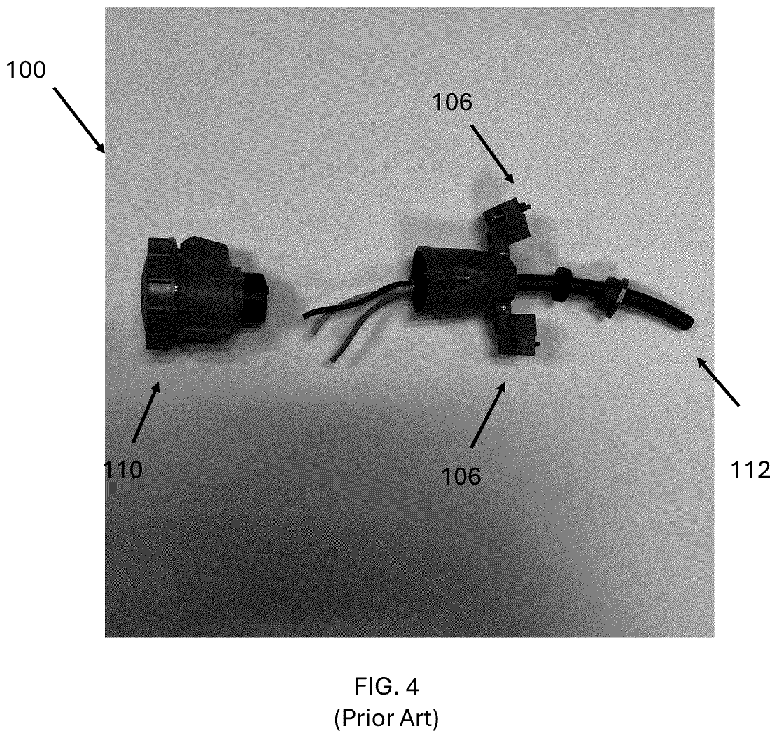

Referring now to FIG. 4, a conventional method of assembly is described. The cord 112 is inserted through a compression screw 114, the cord seal 116, and the back body 108. The insulation is stripped off the conductors, inserted into the contact terminals 110, and terminal screws are tightened to secure the conductors in the terminals, as should be understood by a person of ordinary skill in the art in conjunction with a review of this disclosure.

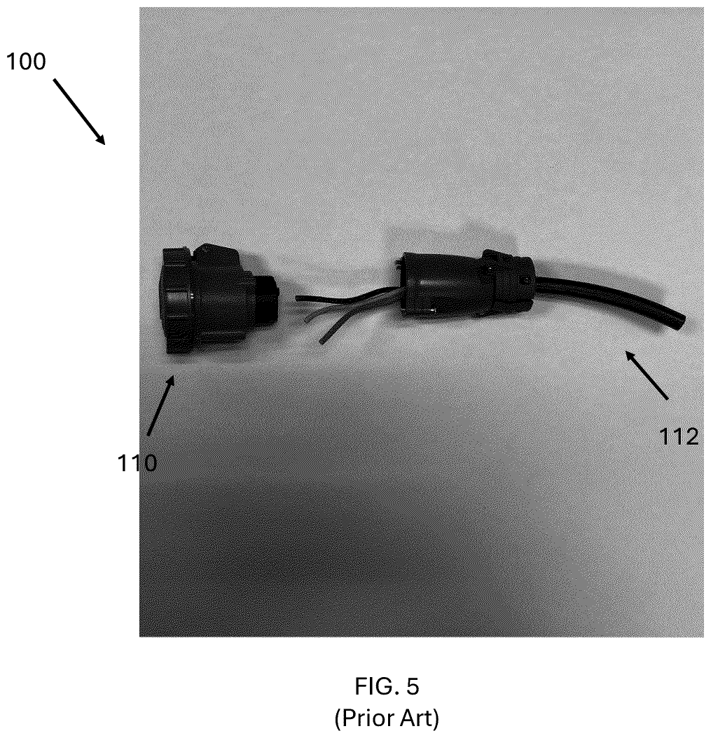

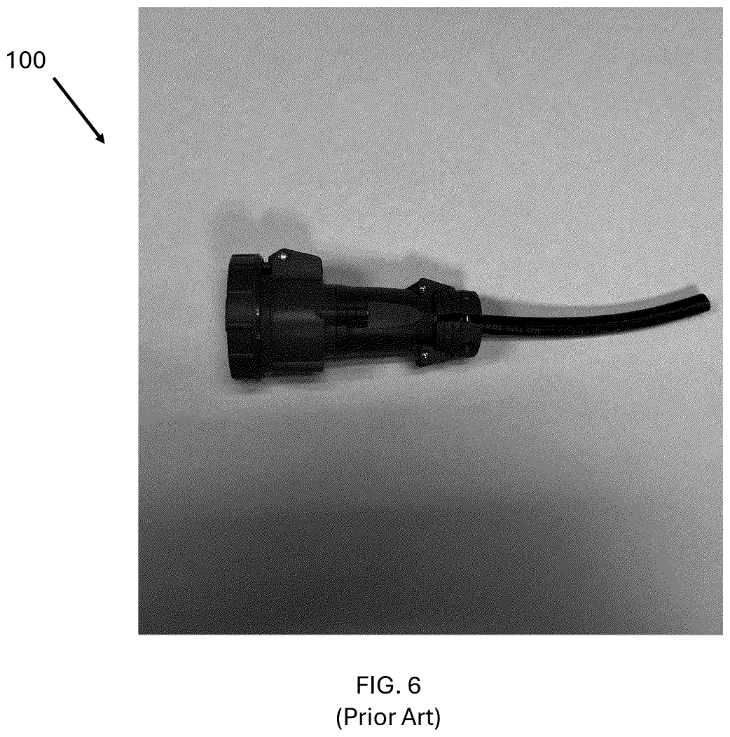

Referring now to FIG. 5, the cord 112 is assembled to the back body 108. To assemble the conventional plug and connector device 110, a user can insert the cord seal 116 into the back body 108 and screw the compression screw 114 into the back body 108, compressing the cord seal 116. The compression of the cord seal 116 causes a reduction of the inner diameter sealing the outside surface of the cord 112. The compression causes an increase of the outer diameter sealing the inside surface of the back body 108. The sealing of the cord 112 and back body surfaces 108 prevent encroachment of solids and fluids. The cord clamps 106 are rotated to engage the cord 112 and are tightened to provide a strain relief. The assembly of the plug 102 is the same as described above (as should be known by a person of ordinary skill in the art in conjunction with a review of this disclosure). A fully assembled conventional plug and connector device 100 is shown in FIG. 6.

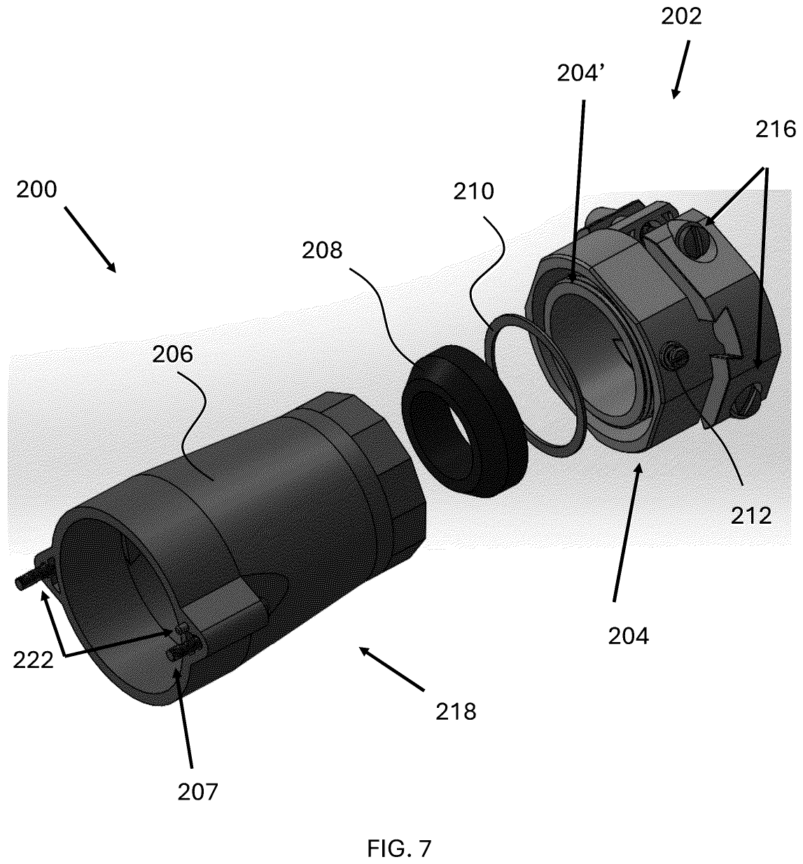

Referring to FIGS. 7-10, an exemplary pin and sleeve device 200 is shown. Unlike conventional devices, in this example, a cord clamp 202 is placed on a compression screw (forming a compression screw/cord clamp assembly 204) as opposed to the connector back body 206 as explained above. Referring to FIG. 7, in this example, the cord clamp 202 does not swing or pivot like a conventional device, but can have two portions (e.g., one unthreaded cord clamp 202-1 and one threaded cord clamp 202-2) that can move (e.g., slide) away from (e.g., to open) and toward each other (e.g., to close) (i.e., away and towards a central axis of the device 200, respectively, as shown, and from a min. sized opening to a max. sized opening and a plurality of sizes therebetween) and accept and hold tight/secure a cord (which can be of a variety of sizes, as should be understood by a person of skill in the art in conjunction with this disclosure) therebetween. The distance between the two portions (i.e., the cord receiving opening) can be altered depending on the diameter of the cord and secured in place with the compression screw when the desired fit is achieved. In other words, this allows for the acceptance of a wide range of cord diameters (e.g., ranging from greater than about 1 7/16 inches to less than about ½ inches in diameter), allowing the pin and sleeve device 200 to accommodate a wider range of cords through the cord receiving opening rather than relying on two pivoting pieces that cannot be altered at the compression screw to increase or decrease the opening therebetween, as explained above.

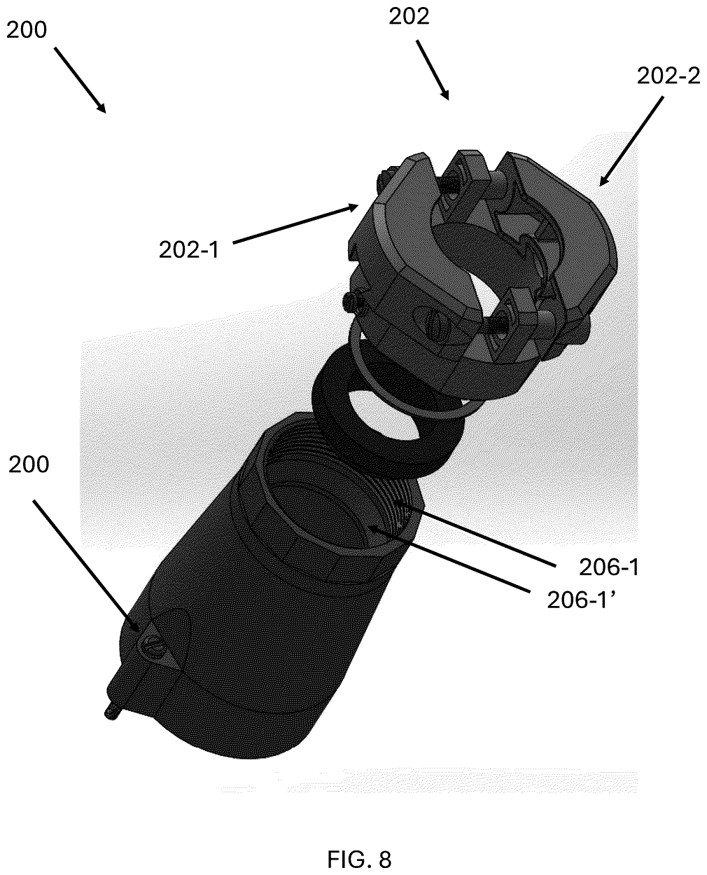

The compression screw/cord clamp assembly 204 can include one set of threads 204′ and a separate back body 206 can include one set of threads 206-1 (see FIG. 8) which can mate with the threads 204′ on the compression screw/cord clamp assembly 204.

Still referring to FIG. 7, according to an embodiment, the back body assembly can have a back body 206 with assembly screws 207, a cord seal 208, a thrust washer 210, and the compression screw/cord clamp assembly 204.

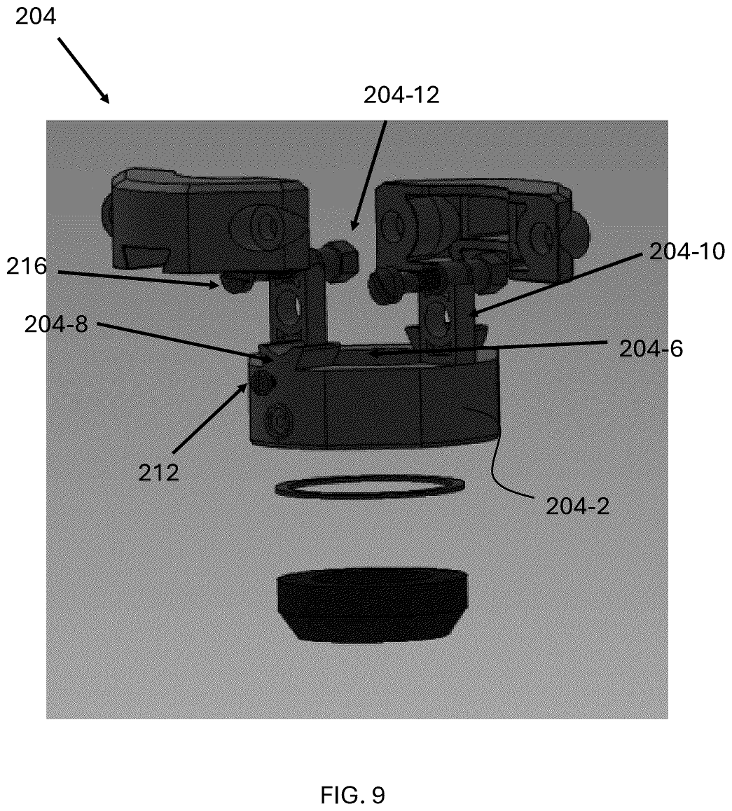

As shown in FIG. 8, an internal thread 206-1 can be positioned at one end and a tapered feature 206-1′ can be positioned on the inner surface thereof that can facilitate the compression of the cord seal 208 (as should be understood by a person of ordinary skill in the art in conjunction with a review of this disclosure). The exterior of the threaded end can have a circular pattern of flat surfaces which can serve as surfaces against which an anti-rotation screw/push pin 212 can engage (see, e.g., FIG. 9). In this example, the interior volume is sufficient to allow the packing of conductors when assembled to the contact assembly. The end opposite the threaded end can be flat and smooth and serve as a sealing surface for the gasket between the back body 206 and the terminal assembly, as described below. A peg 222 can protrude from this surface to ensure the correct back body assembly 218 connects to the plug or connector terminal assembly (see FIG. 7). The plug body differs from the connector back body with the presence of a shark fin feature 103 (see FIG. 1) and the location of the peg 222. As shown in FIG. 7, two screws 207 can be present on this end and serve as fasteners to the terminal assembly.

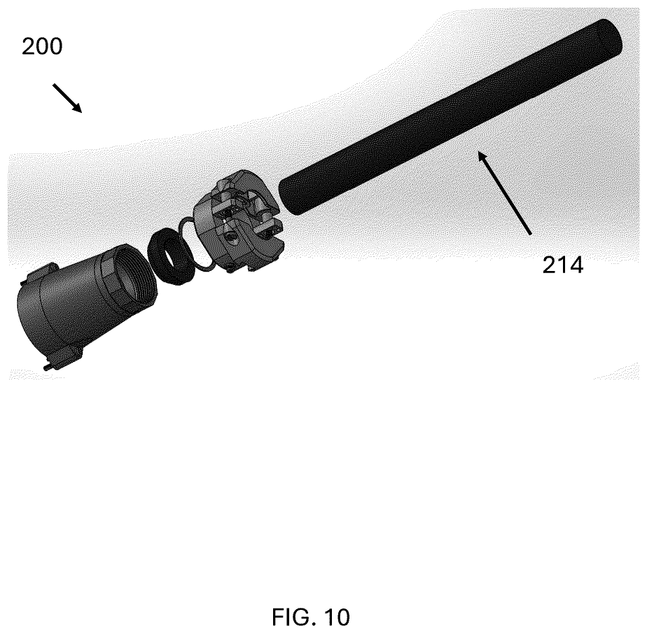

Referring again to FIG. 7, in this embodiment, the cord seal 208 can be a flexible material (including but not limited to rubber or elastomer bushing) that, when compressed, can seal the outer surface of a cord 214 (see FIG. 10) and the inner surface of the back body 206. In this example, the outer diameter can be sized to allow for the seal 208 to be inserted into the back body 206. The inner diameter can be sized to allow for the cord 214 to pass therethrough. In this example, one end of the seal 208 has a square corner and the opposite end is beveled at an angle equal to that of the taper in the back body 206.

Still referring to FIG. 7, in this embodiment, the thrust washer 210 can be a thin plated steel washer that servers to reduce friction between the cord seal 208 and compression screw/cord clamp 204 when the later screws into the back body 206, compressing the cord seal 208.

Referring again to FIGS. 7-10, in this embodiment, the compression screw/cord clamp assembly 204 can compress the cord seal 208 and serve as a strain reliever for the cord 214. Referring specifically to FIG. 9, the assembly 204 can consist of multiple components, such as a base 204-2 with a screw encased in an annular ring 204-6, a dove tail 204-8, one or more support columns 204-10, one or more threaded brass inserts 204-12, one or more cord clamp screws 216, and an anti-rotation screw/push pin 212. The cord clamps 202 can be fastened together and guided by the dovetails 204-8. When screwed into the back body 206, the assembly 204 can drive the cord seal 208 into the back body 206 taper, compressing the seal 208 and sealing the cord 214 and back body 206. The anti-rotation screw 212 can then be driven in engaging one of the flat surfaces on the back body 206. The cord 214 can be positioned between the cord clamps 202 and the cord clamp screws 216 driven to clamp the cord 214 between the two cord clamps 202.

When the above items are assembled, the back body assembly 218 is formed. To assemble to a plug or connector, a user can separate the terminal assembly from the back body assembly 218, insert the cord 214 through the back body assembly 218, fasten the conductors to the contact terminals, reassemble the terminal assembly and back body assembly, screw the compression screw 204 into the back body 206 until it is tight, then engage the anti-rotation screw/push pin 212, and center the cord 214 between the cord clamps 202 and tighten the cord clamp screws 216.

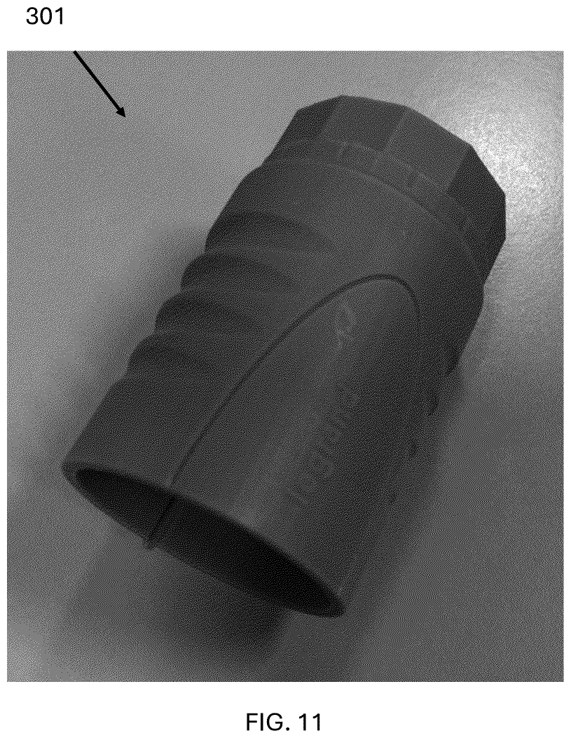

In accordance with an alternative embodiment, with reference to conventional locking devices (e.g., NEMA WD 6), back body 206 can be replaced by back body 301, as shown in FIG. 11. Back body 301 differs from back body 206 with the absence of assembly screws 207, location pegs 222, and a shark fin 103 (see e.g., FIGS. 1 and 8).

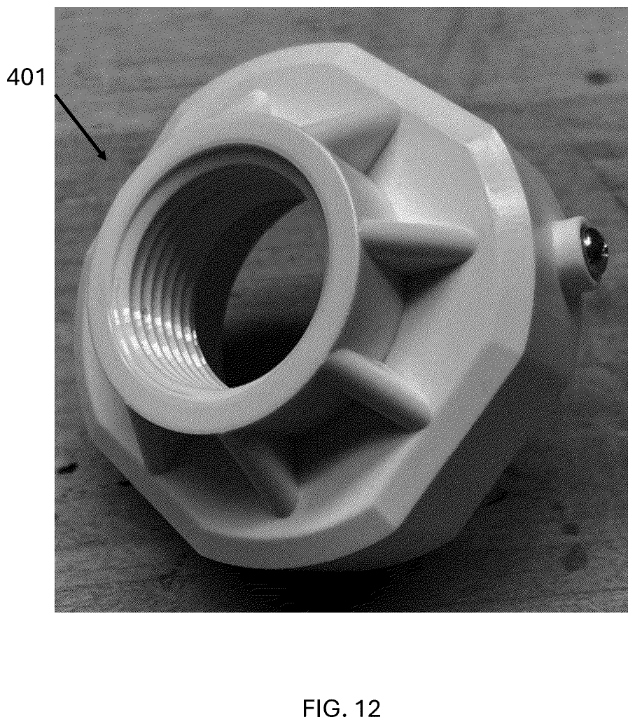

In accordance with another alternative embodiment, an assembly utilizing a watertight or non-watertight secondary thread 401, as shown in FIG. 12, may be used in place of the cord clamp assembly 204.

It should be understood that any of the specific dimensions recited in this application can apply to any embodiment described above. All embodiments can be combined in any way mechanically possible.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprise” (and any form of comprise, such as “comprises” and “comprising”), “have” (and any form of have, such as, “has” and “having”), “include” (and any form of include, such as “includes” and “including”), and “contain” (any form of contain, such as “contains” and “containing”) are open-ended linking verbs. As a result, a method or device that “comprises”, “has”, “includes” or “contains” one or more steps or elements. Likewise, a step of method or an element of a device that “comprises”, “has”, “includes” or “contains” one or more features possesses those one or more features but is not limited to possessing only those one or more features. Furthermore, a device or structure that is configured in a certain way is configured in at least that way but may also be configured in ways that are not listed.

The corresponding structures, materials, acts and equivalents of all means or step plus function elements in the claims below, if any, are intended to include any structure, material or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the present invention for various embodiments with various modifications as are suited to the particular use contemplated.

What is claimed is:

1. A cord clamp assembly, comprising:
a back body; and
a cord clamp releasably coupled to the back body, the cord clamp comprising:
a base;
a first clamp portion and a second clamp portion coupled to the base, wherein the first and second clamp portions are cooperatively configured to define a cord-receiving opening;
wherein at least one of the first and second clamp portions is further configured to be movable relative to the other to adjust a diameter of the cord-receiving opening;
wherein moving the at least one of the first and second clamp portions from a first position to a second position increases the diameter of the cord-receiving opening to a first diameter; and
wherein moving the at least one of the first and second clamp portions from the second position to a third position increases the diameter of the cord-receiving opening to a second diameter.

2. The cord clamp assembly of claim 1, wherein the second diameter is larger than the first diameter.

3. The cord clamp assembly of claim 1, wherein the first and second clamp portions are secured in position via one or more compression screws.

4. The cord clamp assembly of claim 1, further comprising an anti-rotation screw coupled to the base of the cord clamp.

5. The cord clamp assembly of claim 1, wherein the at least one of the first and second clamp portions are configured to move along a longitudinal axis relative to the cord clamp.

6. The cord clamp assembly of claim 1, wherein the first clamp portion is an unthreaded cord clamp.

7. The cord clamp assembly of claim 1, wherein the second clamp portion is a threaded cord clamp.

8. The cord clamp assembly of claim 1, further comprising a cord seal configured to be positioned between the back body and the cord clamp when assembled.

9. The cord clamp assembly of claim 1, wherein the back body and the cord clamp form a central cavity therebetween when assembled.

10. The cord clamp assembly of claim 1, further comprising a plurality of first threads integrally formed with the back body.

11. The cord clamp assembly of claim 10, further comprising a plurality of second threads integrally formed with the cord clamp and configured to match with the plurality of first threads of the back body.

12. A pin and sleeve device, comprising:
a cord clamp configured to be releasably coupled to a back body, the cord clamp comprising:
a base;
a first clamp portion and a second clamp portion coupled to the base, wherein the first and second clamp portions are cooperatively configured to define a cord-receiving opening;
wherein at least one of the first and second clamp portions is further configured to be movable relative to the other to adjust a diameter of the cord-receiving opening;
wherein moving the at least one of the first and second clamp portions from a first position to a second position increases the diameter of the cord-receiving opening to a first diameter; and
wherein moving the at least one of the first and second clamp portions from the second position to a third position increases the diameter of the cord-receiving opening to a second diameter; and
a cord seal configured to be positioned at an end of the cord clamp when assembled.

13. The pin and sleeve device of claim 12, wherein the second diameter is larger than the first diameter.

14. The pin and sleeve device of claim 12, wherein the first and second clamp portions are biased in position via one or more compression screws.

15. The pin and sleeve device of claim 12, further comprising a washer positioned between the cord seal and the cord clamp when assembled.

16. The pin and sleeve device of claim 12, wherein the at least one of the first and second clamp portions are configured to move along a longitudinal axis relative to the cord clamp.

17. The pin and sleeve device of claim 12, wherein the first clamp portion is an unthreaded cord clamp.

18. The pin and sleeve device of claim 12, wherein the second clamp portion is a threaded cord clamp.

19. The pin and sleeve device of claim 12, further comprising a cord seal configured to be positioned between the back body and the cord clamp when assembled.

20. The pin and sleeve device of claim 12, further comprising a washer configured to be positioned between the cord seal and the cord clamp when assembled.
